(19) United States
(12) Patent Application Publication
(10) Pub. No.: US 2004/0076075 A1
(43) Pub. Date: Apr. 22, 2004

(54) Device for securing the handle of a container which is placed on a mixing machine

(76) Inventors: Roberto Avanzi, Massa Finalese (IT); Marco Lunghini, Camposanto (IT)

Correspondence Address: Flynn Thiel, Boutell & Tanis, 2026 Rambling Road, Kalamazoo, MI, 49008-1699, US

(21) Appl. No.: 10/473,490

(22) PCT Filed: Mar. 28, 2002
(86) PCT No.: PCT/IB02/01076

(30) Foreign Application Priority Data
Apr. 2, 2001 (IT) BO2001A000197

(51) Int. Cl. B01F 11/00; B01F 15/00

(52) U.S. Cl. 366/209

(57) ABSTRACT

A device for securing the handle of a container placed on a mixing machine of the type comprising support means (10, 12) for the container comprises at least one resiliently flexible member (14) which is coupled to the support means (10, 12) and which is adapted for pressing, when in use, against the handle in order to keep it near the container when the container is placed in the operating mixing position.

The present invention relates to the sector of machines for mixing fluid products, by way of non-limiting example, varnishes, paints, enamels, inks, and the like, which are disposed in containers, tins, drums and cans which are often provided with a handle for the carrying thereof. Depending on the type of mixing machine used, the containers are subjected during the mixing to various shaking and rotating movements which cause the homogenization of the components of the fluid product. At the same time, if there is no provision for some means of fixing the handle of the container, the handle remains free to flap as a result of the movements imparted by the mixing machine, thereby spoiling the outside surface of the container, or damaging itself, besides causing an irritating noise. In extreme cases, the handle can even interfere with the mechanical members of the mixing machine, causing serious damage to the machine, as well as being at risk of being torn off from the container, resulting in the opening thereof and the consequent harmful discharge of fluid product.

The above-described disadvantages affect in particular mixing machines used on industrial production lines, because in this case it is not possible, or proves to be particularly difficult, to fix the handle to the surface of the container beforehand by means, for example, of an adhesive strap or similar systems.

The present invention proposes to overcome the above-mentioned disadvantages by providing a device for securing the handle of a container when the container is placed on a mixing machine and subjected to mixing operations. The invention also has the objective or providing a device constructed simply and economically which does not need any manual intervention, is reliable to use and which can be used in mixing machines of different types.

In order to fulfil the above-indicated objectives, the subject-matter of the invention is a device for securing the handle of a container placed on a mixing machine of the type comprising support means for the container, characterized in that the device comprises at least one resiliently flexible member which is coupled to the support means and which is adapted for pressing, when in use, against the handle in order to keep it positioned against the container when the container is placed in the operating mixing position.

In a variant of the invention, the device can be adjusted in order to be adapted to different forms and dimensions of containers which are to be placed on the mixing machine. A further variant provides for automatic adjustment of the device in accordance with the container which is actually loaded on the mixing machine.

Further features and advantages will be appreciated from the description below, done by way of non-limiting example with reference to the Figures, in which:

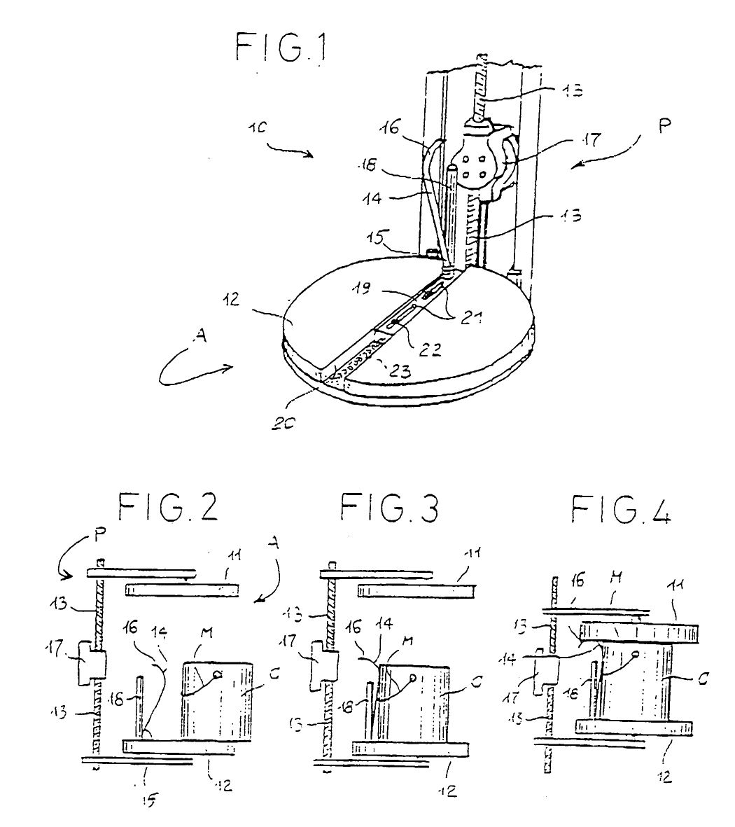

FIG. 1 is a perspective view of the device according to the invention associated with the lower plate of the clamping unit of a machine for mixing fluid products,

FIGS. 2 to 4 are longitudinal sections of the clamping unit o the mixing machine in the preceding Figure which illustrate three operating phases of the device according to the present invention.

Now with reference to the Figures, a clamping and support unit 10 is intended to support and clamp a container C for fluid products, which is provided with a handle M, during the mixing operations. The clamping and support unit 10 generally comprises a pair of plates 11, 12 which are intended to clamp between them the container C. The plates can be moved towards each other by means of screw-type members 13 or any other system suitable for the purpose and of a type known to persons skilled in the art. Examples of mixing machines and clamping systems for containers are described in the applicant's documents EP-0680778 and EP-0617998. In particular, the clamping system which is illustrated in the Figures relates to a gyroscopic mixer, although the present invention can be applied to mixers of a different type, for example, of the vibrating type. The clamping unit 10 has a front A, from which the container C is normally introduced, and a rear 2, where the handling members 17 for the clamping of the plates 11, 12 and for moving the clamping unit 10 during the mixing operations are generally positioned.

On the lower plate 12 is mounted a flexible resilient member 14, in particular, but not exclusively, a flexible band of harmonic steel or a different suitable material, which extends in the direction of the upper plate 11. In the embodiment illustrated in the Figures, the lower end 15 of the flexible member is arranged near the rear P of the clamping unit 10. The flexible member 14 is inclined towards the front A of the clamping unit 10 and terminates with the upper end 16 thereof curved towards the rear P. In the embodiment of the Figures, the lower end 15 of the flexible member 14 is fixed to the base of a support 18 which extends in a direction which is substantially perpendicular to the upper plate 11 from a slide 19 which is fitted in the recessed manner in a recess 20 which is formed in the lower plate 12. The slide 19 is provided with slots 21, in which are arranged guide pins which are provided with clamping nuts 22, or similar means, which allow adjustment and fixing of the slide 19 in positions which are more or less advanced in respect of the front A of the clamping unit 10.

In a variant of the invention, the slide 19 is not provided with the clamping nuts 22 and is instead provided with an automatic system for adjusting the position thereof depending on the dimensions of the container C which is placed on the clamping unit 10. This adjustment system can comprise, in the simplest form thereof, a biasing element 23, for example, a spring (illustrated by a broken line in FIG. 1) which tends to return the slide 19, and therefore the flexible member 16, towards the centre of the plate 12 when no container is placed thereon. In this variant of the invention, the introduction of a container C from the front A, carried out, for example, by automatic means, such as mechanical hands, or the like, acts counter to the resilient force of the biasing element 23, pushing the slide 19 towards the rear P of the clamping unit 10.

When the above-described automatic adjustment is not provided in the device according to the present invention, the adjustment of the position of the flexible resilient element 14 is carried out manually by loosening the nuts 22 and by causing the slide 19 to slide along the recess 20 until the desired position of the resilient element 14 is reached, for example, the most suitable position for securing the handle M of a given number of containers C having similar dimensions and shapes. This manual adjustment is not necessary in the case of the above-described variant which comprises the sing 23, in which the position of the slide 13 is automatically determined on the introduction of the container C into the mixing machine.

When in use, as is visible in FIG. 2, a container C is introduced from the front A of the clamping unit 10 in such a manner that the handle M, which is arranged on the lateral surface of the container C, is turned towards the rear P of that clamping unit. When the container C is pushed into the operating mixing position at the centre of the lower plate 12 as illustrated in FIG. 3, the flexible member 14 presses against the handle M, securing it against the lateral surface of the container C.

Although the resilient pressure applied by the flexible member 14 against the handle M is already, per se, sufficient to obtain the desired result, it is also possible to arrange the flexible member 14 in such a manner that the upper end 16 thereof is pressed by the upper plate 11, as illustrated in FIG. 4, in such a manner that the resilient force of the flexible member 14 against the handle M of the container C is further increased. In any case, the pressure of the resilient member 14 against the handle M prevents any movement thereof during the mixing operations, carried out by setting in movement the clamping unit according to a method known in the sector.

At the end of the mixing operations, the plates 11 and 12 are moved away from each other in order to allow the removal of the container C from the clamping unit 10. Subsequently, the flexible resilient element 14 returns to the original position illustrated in FIGS. 1 and 2.

Of course, whilst the principle of the invention remains unchanged, the embodiments and the details of implementation can vary extensively in relation to the description and illustrations, without in anyway departing from the scope or the present invention.

1. Device for securing the handle (M) of a container (C) which is placed on a mixing machine of the type comprising support means (10, 11, 12) for the container (C), characterized in that the device comprises at least one resiliently flexible member (14) which is coupled to the support means (10, 11, 12) and which is adapted for pressing, when in use, against the handle (M) in order to keep it positioned against the container (C) when the container is placed in the operating mixing position.

2. Device according to claim 1, characterized in that the flexible member extends towards a front (A) of the support means (10, 11, 12), from which the container (C) is introduced when in use.

3. Device according to claim 2, characterized in that the flexible member (14) comprises a plate having a first end (15) which is coupled to the support means (10, 11, 12) and a second end (16) which is curved in the direction of a rear portion (P) of the support means that is remote from the front portion (A).

4. Device according to any one of the preceding claims, characterized in that the support means (10, 11, 12) comprise a support plate (12), on which is slidingly mounted a slide (19), to which the flexible member (14) is fixed.

5. Device according to claim 4, characterized in that a support (18) extends from the slide (19) in a direction substantially perpendicular to the support plate (12), the first end (15) of the flexible member (14) being fixed to the support (18) near the slide (19).

6. Device according to claim 4, characterized in that the slide (19) is slidingly mounted in a recess (20) which is formed in the support plate (12).

7. Device according to claim 4, characterized in that it comprises a system for adjusting the position of the slide (19), comprising a biasing element (23) which is coupled to the slide (19) in order to return it towards the centre of the support plate (12) when no container (C) is placed thereon.

8. Method for securing the handle (M) of a container (C) by means of a device according to any one of claims 1 to 7, characterized in that it comprises the steps of:
preparing a container (C) with the handle (M) bearing against the lateral surface thereof,
introducing the container (C) from the front (A) of the support means with the handle (M) orientated towards the flexible member (14),
pushing the container (C) into an operating mixing position in such a manner that the flexible member (14) presses against the handle (M) and keeps it near the container (C).
